(19) United States
(12) Patent Application Publication
(10) Pub. No.: US 2020/0378338 A1
(43) Pub. Date: Dec. 3, 2020

(54) Supercritical Stirling Cycle Heat Engine with Accumulators

(71) Applicant: Matthew David Marko, Seaside Heights, NJ (US)

(72) Inventor: Matthew David Marko, Seaside Heights, NJ (US)

(21) Appl. No.: 16/428,989

(22) Filed: Jun. 1, 2019

(51) Int. Cl. F02G 1/044; F02G 1/053; F02G 1/055; F02G 1/06

(52) U.S. Cl. CPC F02G 1/0445; F02G 1/053; F02G 2244/08; F02G 1/06; F02G 1/055

(57) ABSTRACT

The inventor claims a heat engine that follows a modification of the Stirling thermodynamic heat engine cycle. This cycle uses supercritical argon gas to take advantage of the attractive intermolecular forces of the working fluid to assist in compressing the working fluid, reducing the input compression work and the heat output during isothermal compression, as well as reducing the heat input during isothermal expansion, and increasing the overall heat engine efficiency. This cycle utilizes accumulators to ensure the working fluid is heated and cooled isochorically, and a proximate piston-cylinder filled with ideal-gas helium is used in lieu of a regenerator during the isochoric heating and cooling. All of these modifications serve to increase the overall thermodynamic efficiency of the heat engine cycle.

### BACKGROUND OF THE INVENTION

This patent application claims priority to U.S. Provisional Patent Application Ser. No. 62/681,054, filed Jun. 5, 2018 which is incorporated herein by reference in its entirety.

From well before recorded human history, man has quested for different sources of energy for survival and comfort. Today, the need for useful energy plays a role in almost all aspects of society. Certainly, there is a benefit to having an efficient source of mechanical energy. When designing an engine, heat pump, or other thermodynamic cycle, one can not get around the laws of thermodynamics. Prevalent is the first law, which stipulates the conservation of energy; no energy can be created or destroyed. The second law is a result of the fact that heat can only flow from hot to cold, and not cold to hot; as a result, heat transfer processes ultimately result in thermodynamic disorder known as entropy throughout the universe. These two natural limitations have to be recognized in the design of a thermodynamic machine to achieve a net mechanical work output.

Under dense, pressurized conditions, a fluid ceases to become an ideal gas, and becomes a real gas following its equation of state. At a certain point, the intermolecular attractive forces of the fluid causes the gas to condense to a liquid, where these forces are too much for the kinetic energy of the fluid molecules to overcome, and the particles converge into a more ordered liquid state if the temperature is below the critical point. Above the critical temperature, the fluid is consistently a gas; when the density is greater than the critical density the gas-like fluid is often referred to as super-critical. A super-critical fluid is a gas that is significantly influenced by its intermolecular forces due to the close proximity of the energetic fluid molecules, and the internal energy of a supercritical fluid may well be greater than an ideal gas at the same temperature on account of the potential energies between molecules.

### BRIEF SUMMARY OF THE INVENTION

The inventor claims a closed-loop, internally reversible, piston-cylinder heat engine, not dissimilar to the Stirling cycle. Rather than use an ideal gas, this cycle uses a real fluid that becomes supercritical during the isothermal compression stage of the cycle. The isothermal compression phase starts off as a real gas, at a temperature and specific volume greater than the critical point, and compresses isothermally at the cool temperature until the specific volume is less than the critical specific volume. It then is heated to the hot temperature isochorically. Afterwards, it expands isothermally back to the original specific volume, recovering energy in the process. Finally, the gas is cooled isochorically back to the original stage pressure and temperature. Because of these intermolecular forces, the pressure is reduced during the isothermal compression; this ultimately results in less work input to compress the gas isothermally, and thus greater efficiency of the heat engine.

To achieve high thermodynamic efficiencies, this heat engine uses accumulators designed to keep the working fluid at a constant volume during isochoric heating and cooling, all the while allowing for continuous motion of the heat engine piston.

The inventor claims a proximate heat pump that utilizes small temperature differentials in the surrounding ambient fluids to provide a cold temperature sink for the supercritical Stirling cycle heat engine. With this cold temperature sink, the supercritical Stirling cycle heat engine is heated by small temperature differentials in the ambient surrounding fluids. Rather than use a regenerator, this heat pump ensures that the isochoric heating and cooling happens by the nearly reversible compression and expansion of a piston filled with ideal-gas helium to minimizes the temperature difference between heat transfer and maximize the efficiency of the cycle. This heat pump utilizes a mechanical energy input from a crank shaft that is also connected to the supercritical Stirling cycle heat engine. This crankshaft maintains angular momentum via an attached flywheel, and recovers the mechanical rotational energy consumed by the heat pump from the supercritical Stirling cycle heat engine. Due to the enhanced thermodynamic efficiency of the supercritical Stirling cycle heat engine, a net positive mechanical work is generated to the crankshaft and flywheel. This net output allows for the entire machine to function as a mechanical energy generator, utilizing small temperature differences from the surrounding ambient fluids as an input, to generate useful rotating mechanical energy as an output.

### BRIEF DESCRIPTION OF THE FIGURES

FIG. 1 Front Schematic of Heat Engine, Stage 1.

FIG. 2 Front Schematic of Heat Engine, Stage 2.

FIG. 3 Front Schematic of Heat Engine, Stage 3.

FIG. 4 Front Schematic of Heat Engine, Stage 4.

FIG. 5 Side Schematic of Heat Engine.

FIG. 6 Top Schematic of Heat Engine.

FIG. 7 Pressure-specific volume plot of theoretical supercritical argon heat engine thermodynamic cycle—Version 1.

FIG. 8 Height of Heat Engine Piston per crankshaft revolution—Version 1.

FIG. 9 Height of Heat Pump Piston per crankshaft revolution—Version 1.

FIG. 10 Height of External Accumulator Piston per crankshaft revolution—Version 1.

FIG. 11 Height of Heat Engine Accumulator Piston per crankshaft revolution—Version 1.

FIG. 12 Pressure-specific volume plot of theoretical supercritical argon heat engine thermodynamic cycle—Version 2.

FIG. 13 Height of Heat Engine Piston per crankshaft revolution—Version 2.

FIG. 14 Height of Heat Pump Piston per crankshaft revolution—Version 2.

FIG. 15 Height of External Accumulator Piston per crankshaft revolution—Version 2.

FIG. 16 Height of Heat Engine Accumulator Piston per crankshaft revolution—Version 2.

FIG. 17 Pressure-specific volume plot of theoretical supercritical argon heat engine thermodynamic cycle—Version 3.

FIG. 18 Height of Heat Engine Piston per crankshaft revolution—Version 3.

FIG. 19 Height of Heat Pump Piston per crankshaft revolution—Version 3.

FIG. 20 Height of External Accumulator Piston per crankshaft revolution—Version 3.

FIG. 21 Height of Heat Engine Accumulator Piston per crankshaft revolution—Version 3.

### HEAT ENGINE COMPONENTS

(1) The heat engine chamber. It is filled with helium, and contains the heat engine, heat pump, and accumulator cylinder. It can be any shape, but the volume of free space surrounding the cylinders is 0.1313 m³ of helium, when the heat pump is at Top Dead Center.
(2) The heat engine, a cylinder with a bore of 105 mm and a total length of 152.7 mm. This cylinder is sealed from the surrounding chamber (Part 1), but thermally conductive with the surrounding helium (Part 7). The inner wall of the heat engine cylinder has a tungsten disulfide (WS₂) dry lubrication, with a coefficient of kinetic friction of 0.03.
(3) The heat engine piston, sealed with two 2 mm thick piston rings.
(4) The Argon working fluid, with a mass of 33.3545 grams.
(5) The heat pump, a cylinder with a bore of 1.7564 m and a total length of 152.7 mm. The inner wall of the heat pump cylinder has a tungsten disulfide (WS₂) dry lubrication, with a coefficient of kinetic friction of 0.03.
(6) The heat pump piston, sealed with two 2 mm thick piston rings.
(7) The heat pump working fluid (helium), a total of 0.5 kg mass. The pressure of the helium in the heat pump and chamber at bottom dead center shall be 4 atmospheres (404.54 kPa).
(8) Accumulator Cylinder, with a diameter of 38.3332 mm, and a length of 152.7 mm.
(9) Accumulator Piston, sealed with two 2 mm thick piston rings. The accumulator piston is thermally insulated.
(10) Accumulator Pneumatic Fluid, with ideal gas helium. The pressure shall be 9.6737 MPa at Bottom Dead Center, and 20.606 MPa at Top Dead Center, operating at 25° C., with a mass of 2.7516 grams of helium.
(11) Accumulator Manifold, where argon (Part 4) under pressure flows into the accumulator.
(12) Heat Engine Connecting Rod
(13) Heat Pump Connecting Rod
(14) Crank Shaft
(15) Flywheel, to maintain a continuous angular speed
(16) Roller Bearings 1
(17) Roller Bearings 2
(18) Top Accumulator Piston, sealed with two 2 mm thick piston rings. This piston is a thermal insulator, so the ideal gas helium above is separated both physically and thermally from the argon working fluid (Part 4).
(19) Mechanical stoppage, to prevent further compression of helium in heat engine cylinder. A minimum length of 38.4286 mm remains from the obstruction and the top of the heat engine cylinder (Part 2).
(20) 1.1676 grams of helium, that shall be at a consistent temperature of 25° C.

### DETAILED DESCRIPTION OF THE INVENTION

In the design of any thermodynamic system to convert heat to and from mechanical work, the laws of thermodynamics must always be considered. The first law of thermodynamics states that energy can not be created or destroyed, and that the change in internal energy equals the heat and work input into the working fluid

δu=δq−δw, (1)

where δu (J/kg) is the change in specific internal energy, δq (J/kg) is the specific heat transfered, and w (J/kg) is the specific work applied across the boundary

δw=P·δv. (2)

It is a priori and intuitively obvious that energy cannot spontaneously appear from nowhere, and this principle is fundamental to thermodynamics.

The second law has been described by Rudolph Clausius in 1854 as heat can never pass from a colder to a warmer body without some other change, connected therewith, occurring at the same time. This principle is a posteriori and consistently observed in nature that heat always flows from hot to cold. The simple reason for this is the fact that due to kinetic theory, the square root of the temperature is proportional to average velocity of a particle vₘ (m/s)

$${v}_{m} = \sqrt{\frac{3 \cdot κ \cdot T}{{m}_{m}}} , \qquad ( 3 )$$

where κ represents the Boltzman's Constant (1.38·10⁻²³ J/K) and mₘ (kg) is the mass of a molecule. When there is heat transfer, the higher velocity particle from the hotter matter transmits energy when it impacts the lower velocity molecule.

In addition, Clausius' Theorem (a posteriori) for the second law

$$∮ \frac{δ q}{T} \leq 0 , \qquad ( 4 )$$

states that any internally reversible thermodynamic cycle must generate a positive entropy δs≥0 to the surrounding universe, where the change in entropy δs (J/kg·K) is defined as

$$δ s = \frac{δ q}{T} , \qquad ( 5 )$$

where T (K) is the absolute temperature, and δq (J/kg) represent the heat transfered per unit mass.

An internally reversible thermodynamic heat engine cycle with no increase in universal entropy δs=0 is the definition of the idealized Carnot efficiency η_{C} of a heat engine

$${η}_{C} = \frac{{w}_{o u t}}{{q}_{in}} = \frac{{q}_{in} - {q}_{o u t}}{{q}_{in}} = 1 - \frac{{T}_{L}}{{T}_{H}} , \qquad ( 6 )$$

where wₒᵤₜ (J/kg) is the net work output, qᵢₙ (J/kg) and qₒᵤₜ (J/kg) are the heat input and output at the hot T_{H} (K) and cold T_{L} (K) temperatures, and η_{C} represents the efficiency of a heat engine where there is no increase in entropy δs=0,

$$δ s = \frac{{q}_{in}}{{T}_{H}} - \frac{{q}_{o u t}}{{T}_{L}} = 0 , \\ \frac{{q}_{o u t}}{{q}_{in}} = \frac{{T}_{L}}{{T}_{H}} ,$$

and thus

$${η}_{C} = \frac{{q}_{in} - {q}_{o u t}}{{q}_{in}} = 1 - \frac{{q}_{o u t}}{{q}_{in}} = 1 - \frac{{T}_{L}}{{T}_{H}} .$$

A Carnot heat pump is simply a Carnot heat engine in reverse, and thus the Coefficient of Performance (COP) where δs=0 is

$$C O {P}_{C} = \frac{1}{{η}_{C}} = \frac{{q}_{o u t}}{{w}_{in}} = \frac{1}{1 - \frac{{T}_{L}}{{T}_{H}}} . \qquad ( 7 )$$

If a heat pump were designed so that the heat output would entirely supply the heat input of a heat engine, and then the work output of the heat engine would supply the work input of a heat pump, this system would run indefinitely provided that

$${η}_{H E} \geq \frac{1}{C O {P}_{H P}} , \qquad ( 8 )$$

and if equation 8 does not hold true, then a work input will be constantly needed to keep the heat-pump-heat-engine system running. Since heat always flows from hot to cold, for this system to be possible the temperate range of the heat pump must be equal or greater than that of the heat engine

T_{H,HE}≤T_{H,HP},

T_{L,HE}≥T_{L,HP},

and therefore if both the heat pump and heat engine maintained the ideal Carnot COP_{C} and efficiency η_{C}, and the temperature difference was minimized so that T_{H,HE}=T_{H,HP} and T_{L,HE}=T_{L,HP}, then η_{HE}=1/COP_{HP}. If the heat pump or the heat engine ever exceeded the Carnot efficiency and η_{HE}>1/COP_{HP}, then Clausius' Theorem (equation 4) would be violated and there would be negative entropy generated in the universe, and the system could obtain useful work from the ambient temperature, without the need for a temperature differential; this would violate Clausius's definition of the second law defined in equation 4.

The internal energy of an ideal gas is comprised solely of the kinetic energy and is only affected by the temperature. For a real gas, however, the intermolecular forces affect the behavior of the molecules. The impacts of these forces increase as the molecules move closer together, and as the specific volume v (m³/kg) of the fluid decreases. The current equation used to date for the change in specific internal energy u (J/kg) for a real gas is based on the assumptions of entropy defined by Clausius in equation 4

$$δ u = {C}_{V} \cdot δ T + \{ T \cdot {( \frac{\partial P}{\partial T} )}_{V} - P \} \cdot δ v , \qquad ( 9 )$$

where C_{V} (J/kg·K) is the specific heat capacity at a constant volume. The derivation of equation 9 originates from the first law of thermodynamics defined in equation 1, which using equation 5, the first law can then be written as

δu=T·δs−P·δv. (10)

Expanding the partial derivatives of the entropy yields

$$δ s = {( \frac{\partial s}{\partial T} )}_{V} \cdot δ T + {( \frac{\partial s}{\partial V} )}_{T} \cdot δ v , \qquad ( 11 )$$

and due to the symmetry of the second derivative of the Helmholtz free energy

$${( \frac{\partial s}{\partial V} )}_{T} = {( \frac{\partial P}{\partial T} )}_{V} . \qquad ( 12 )$$

By plugging equation 12 into equation 11, and then plugging equation 11 into equation 10, and then defining the specific heat capacity

$$T \cdot {( \frac{\partial s}{\partial T} )}_{V} \cdot δ T = {( \frac{q}{T} )}_{V} \cdot δ T = {C}_{V} \cdot T , \qquad ( 13 )$$

one can get equation 9.

There is experimental evidence available from the National Institute of Standards and Technology (NIST), formerly known as the National Bureau of Standards, to contradict Clausius' definition for the second law defined in equation 4. To realize this, a new theoretical thermodynamic cycle is demonstrated, utilizing a saturated fluid, that generates a net negative entropy and thus disproving the fundamental nature of Clausius' definition for the second law for dense fluids subjected to temperature-dependent attractive intermolecular forces.

The theoretical cycle proposed starts off at a low temperature, saturated gas; this will be referred to as Stage 1. A piston compresses the saturated gas isothermally until it is a saturated liquid (Stage 2), resulting in a decrease in internal energy, a mechanical work input, and a heat output to the cold-temperature sink. Next, the piston expands slowly in a precise manner while the saturated fluid increases in temperature so that the fluid remains a saturated liquid until it is at a higher temperature; this hot saturated liquid will be referred to as Stage 3. During this saturated liquid heating between stage 2 and 3, there is a heat input, an internal energy increase, and a (relatively minimal) mechanical work output. Next, the piston continues to expand isothermally until the fluid is a saturated gas at the hot temperature; this will be referred to as Stage 4. During the hot isothermal expansion, the internal energy will increase significantly, there will be a significant work output on the piston, and a significant heat input as well. Finally, the piston will continue to expand precisely while the saturated gas is cooled, so that it remains a saturated gas, until the temperature returns to a saturated gas at the original cold temperature of Stage 1 and Stage 2. During this saturated gas cooling, there is a decrease in internal energy, a work output, and (usually but not exclusively) a net heat input.

As the density of a fluid increases to the point of being a saturated liquid, saturated gas, or supercritical fluid, intermolecular attractive (and repulsive) forces can impact the pressure and temperature of the fluid. As the molecules get closer together in the presence of attractive intermolecular forces, the internal potential energy will decrease. The thermodynamic data yields an empirical equation that closely predicts the change in specific internal energy Δu (J/kg) during isothermal compression and expansion

$$\begin{matrix}Δ u = \frac{{a}^{′}}{\sqrt{T}} \cdot ( \frac{1}{{v}_{1}} - \frac{1}{{v}_{2}} ) , & ( 14 ) \\ {a}^{′} = \frac{{R}^{2} \cdot {T}_{c}^{2.5}}{9 \cdot ( {2}^{\frac{1}{3}} - 1 ) \cdot {P}_{c}} . & \end{matrix}$$

where v₁ and v₂ (m³/kg) represent the specific volume, T represents the temperature, R (J/kg·K) represents the gas constant, T_{C} (K) represents the critical temperature, and P_{C} (Pa) represents the critical pressure. The value of a′ happens to be the same coefficient used in the Redlich-Kwong equation of state; equation 14 does not actually use any equation of state, as it is an empirical equation based on published data by NIST in the literature.

Equation 14 was validated for several different fluids, both the highly polar fluid water; the monatomic fluids of argon, krypton, and xenon; the diatomic fluid nitrogen; ammonia; the hydrocarbons of methane, ethane, propane, and both normal and iso-butane; and the refrigerants Freon R-12, R-22, and R-134a. All of the data provided utilized the available online tables from NIST, in particular NIST Chemistry WebBook, NIST Standard Reference Database Number 69, edited and prepared by P. J. Linstrom and W. G. Mallard. Equation 14 matched remarkably for the change in internal energy during isothermal expansion during vaporization, all over a wide temperature range ΔT (K). The calculated coefficient a′ (Pa·K^{0.5}·m⁶·kg⁻²) and the coefficient of determination R² between the NIST values and equation 14 are all tabulated in Table 1.

TABLE 1
The calculated coefficient α′ (Pa · K^{0.5} · m⁶ ·
kg⁻²) and the coefficient of determination R² between the NIST
values (and equation 9) and equation 14, over a specified temperature range ΔT (K).

| | M | T_{C} | P_{C} | | ΔT | |
|---|---|---|---|---|---|---|
| Fluid | (g/Mole) | (K) | (MPa) | a′ | (K) | R² |
| Water (H₂O) | 18.02 | 647.14 | 22.064 | 43,971 | 274-647 | 0.98572 |
| Argon (Ar) | 39.948 | 150.687 | 4.863 | 1,062 | 84-150 | 0.98911 |
| Krypton (Kr) | 83.798 | 209.48 | 5.525 | 484 | 116-209 | 0.98858 |
| Xenon (Xe) | 131.3 | 289 | 5.84 | 417 | 162-289 | 0.98972 |
| Nitrogen (N₂) | 28.0134 | 126.2 | 3.4 | 1,982 | 64-126 | 0.98565 |
| Ammonia (NH₃) | 17.0305 | 405.4 | 11.3119 | 29,824 | 196-405 | 0.98603 |
| Methane (CH₄) | 16.043 | 190.53 | 4.598 | 12,520 | 91-190 | 0.97818 |
| Ethane (C₂H₆) | 30.07 | 305.34 | 4.8714 | 10,937 | 91-305 | 0.94881 |
| Propane (C₃H₈) | 44.098 | 369.85 | 4.2477 | 9,418 | 86-369 | 0.93372 |
| Butane (C₄H₁₀) | 58.125 | 425.16 | 3.796 | 8,594 | 135-424 | 0.9631 |
| Iso-Butane (C₄H₁₀) | 58.125 | 407.85 | 3.64 | 8,078 | 114-407 | 0.95368 |
| Freon R-12 | 120.91 | 385.12 | 4.1361 | 1,423 | 175-384 | 0.98465 |
| Freon R-22 | 86.47 | 369.295 | 4.99 | 2,077 | 172-369 | 0.98741 |
| Freon R-134a | 102.03 | 374.21 | 4.0593 | 1,896 | 170-374 | 0.9884 |

A Stirling engine cycle is defined by isothermal compression at the cold sink (stage 1-2), isochoric heating from the cold to the hot temperature (stage 2-3), isothermal expansion at the hot source (stage 3-4), and isochoric cooling back from the hot temperature to the cold temperature (stage 4-1). In order that the ideal gas Stirling engine achieve maximum efficiency, there must be perfect regeneration from the isochoric cooling to the isochoric heating. This is thermodynamically possible (though difficult in practice) as the specific heat of an ideal gas is constant regardless of volume, and thus Q₂₃=Q₄₁ over the same temperature range. Provided there is this perfect regeneration, Qᵢₙ=Q₃₄ and Qₒᵤₜ=Q₁₂. For an ideal gas subject to the equation of state defined in equation 15

P·v=R·T, (15)

undergoing isothermal expansion, the heat input q_{δT=0} (J/kg) is equal to the work output W_{δT=0} (J/kg) defined by equation 2

$${q}_{δ T = 0} = {W}_{δ T = 0} = \int P \cdot dv = R \cdot T \cdot \int \frac{d v}{v} = R \cdot T \cdot log ( \frac{{V}_{2}}{{V}_{1}} ) , \qquad ( 16 )$$

and thus the efficiency of an ideal gas Stirling engine is

$$η = 1 - ( \frac{{Q}_{o u t}}{{Q}_{ι n}} ) = 1 - ( \frac{{Q}_{12}}{{Q}_{34}} ) = 1 - ( \frac{R \cdot {T}_{L} \cdot log ( \frac{{V}_{2}}{{V}_{1}} )}{R \cdot {T}_{H} \cdot log ( \frac{{V}_{2}}{{V}_{1}} )} ) = 1 - ( \frac{{T}_{L}}{{T}_{H}} ) , \qquad ( 17 )$$

which is the Carnot efficiency defined in equation 6.

Equation 16 no longer applies when a working fluid is no longer an ideal gas (equation 15) but a real fluid subjected to intermolecular forces such as the Van der Waal forces. As a fluid gets more and more dense, the molecules get closer to each other, and the impact of intermolecular forces increases. When a Stirling Engine uses a dense real fluid as its working fluid, the internal energy will in fact change during isothermal compression and expansion, which can be found with equation 9, and can be simply and accurately approximated with empirical equation 14.

The inventor claims a Stirling engine, using supercritical argon gas as the working fluid. The reduced specific volume at top and bottom dead center are V_{R}=1.5 and V_{R}=15.0, whereas the reduced specific temperatures are T_{R}=1.2951 and T_{R}=1.9786 at the low and hot temperature range. Argon has a molar mass of 39.9 g/mole, a critical pressure of 4.863 MPa, a critical temperature of 150.687 K, and a critical specific volume of 1.8692 cm³/g; therefore the temperature of this Stirling engine ranges between −78° C. and 25° C., and the specific volume ranges between 2.80374 cm³/g and 28.0374 cm³/g. The intermolecular attractive parameter a′ defined in equation 14 is thus 1,063.8 Pa·K^{0.5}·m⁶·kg⁻² for argon. The pressures within this supercritical argon heat engine cycle can be obtained using the Peng-Robinson equation of state

$$\begin{matrix}P = \frac{R \cdot T}{V - B} - \frac{A \cdot α}{{V}^{2} + 2 \cdot B \cdot V - {B}^{2}} , & ( 18 ) \\ A = 0.45724 \cdot \frac{{R}^{2} \cdot {T}_{c}^{2}}{{P}_{c}} , & \\ B = 0.07780 \cdot \frac{R \cdot {T}_{c}}{{P}_{c}} , & \\ α = {( 1 + κ \cdot ( 1 - \sqrt{{T}_{R}} ) )}^{2} , & \\ κ = 0.37464 + 1.54226 \cdot ω - 0.26992 \cdot {ω}^{2} , & \end{matrix}$$

where ω is Pitzer's acentric factor, defined as

$$ω = {log}_{10} ( \frac{{P}_{c}}{{P}_{S}^{′}} ) - 1 , \qquad ( 19 )$$

where P′_{S} (Pa) is the saturated pressure at a reduced temperature of T_{R}=0.7, and P_{c} (Pa) is the critical pressure. For all of the monatomic fluids including argon, ω=0. The thermodynamic properties of the argon working fluid at each stage of this cycle are tabulated in Table 2.

TABLE 2
Pressure P (MPa), specific volume v (cm³/g), temperature T
(° C.), reduced pressure P_{R}, reduced specific volume v_{R}, and
reduced temperature T_{R}, for the Stirling cycle heat engine
utilizing supercritical argon gas as the working fluid.

| Stage | P (MPa) | v (cm³/g) | T (° C.) | P_{R} | v_{R} | T_{R} |
|---|---|---|---|---|---|---|
| 1 | 1.3744 | 28.0374 | −78 | 0.28263 | 15 | 1.2951 |
| 2 | 9.6737 | 2.80374 | −78 | 1.9893 | 1.5 | 1.2951 |
| 3 | 20.6058 | 2.80374 | 25 | 4.2373 | 1.5 | 1.9786 |
| 4 | 2.1744 | 28.0374 | 25 | 0.44713 | 15 | 1.9786 |

By integrating the pressure and the change in volume during the isothermal compression of stage 1-2 and the isothermal expansion of stage 3-4, the work

W=P·dV,

input Wᵢₙ (J/kg) and output Wₒᵤₜ (J/kg) can be determined

Wᵢₙ=78, 237,

Wₒᵤₜ=136, 064,

and by using the proposed equation 14 for the change in internal energy during isothermal compression δu₁₂ (J/kg) and isothermal expansion δu₃₄ (J/kg)

δu₁₂=24, 445,

δu₃₄=19, 777,

the isothermal heat output Q₁₂ (J/kg) and input Q₃₄ (J/kg) can be determined

Q₁₂=Wᵢₙ+δu₁₂=102, 682,

Q₃₄=Wₒᵤₜ+δu₃₄=155, 841.

This engine assumes perfect regeneration, where all of the heat output from isochoric cooling Q₄₁ (J/kg) is used for isochoric heating Q₂₃ (J/kg). This is extremely difficult to practically implement, but absolutely possible thermodynamically. For an ideal gas Q₂₃=Q₄₁; for a real gas this is not the case. In order to determine the difference in heat needed from the hot source δQ₂₃ (J/kg)

δQ₂₃=Q₂₃−Q₄₁=Q₁₂−Q₃₄+Wₒᵤₜ−Wᵢₙ=δu₁₂δu₃₄4, 668,

and this additional heating requirement can be used to find the heat input Qᵢₙ (J/kg) and output Qₒᵤₜ (J/kg) of this engine

Qᵢₙ=Q₃₄+δQ₂₃160, 509,

Qₒᵤₜ=Q₁₂=102, 682.

The heat input and output can be used to find the thermodynamic efficiency of this heat engine

$${η}_{H E} = 1 - \frac{{Q}_{o u t}}{{Q}_{in}} = 1 - \frac{102 , 682}{160 , 509} = 36.027 \% ,$$

which exceeds by 4.3% the theoretical ideal-gas Stirling-cycle efficiency defined in equation 17

$$η = 1 - \frac{{T}_{L}}{{T}_{H}} = 1 - \frac{1.295 \; 1}{1.978 \; 6} = 34.5 \; 45 \% .$$

The change in specific entropy δs (J/kg·K) is defined in equation 5, and the total entropy generated δsᵤ (J/kg·K) in the universe by this internally reversible cycle is thus

$$\begin{matrix}δ {s}_{u} = \frac{{Q}_{o u t}}{{T}_{L}} - \frac{{Q}_{ι n}}{{T}_{H}} , \\ = \frac{102 , 682}{195.15} - \frac{160 , 509}{298.15} , \\ = - 12.180 ,\end{matrix}$$

remarkably demonstrating a net reduction in entropy throughout the universe with a practical piston-cylinder heat engine that has a realistic compression ratio of 10.

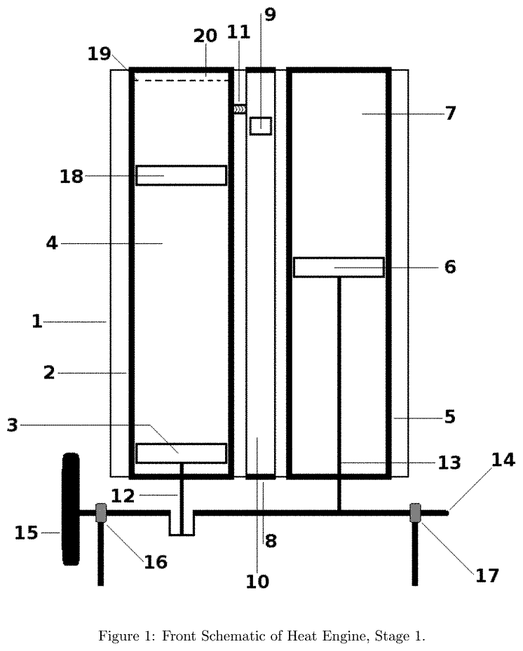

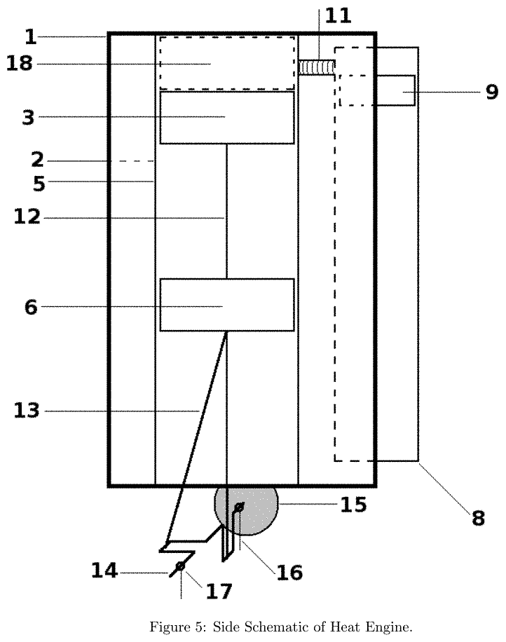

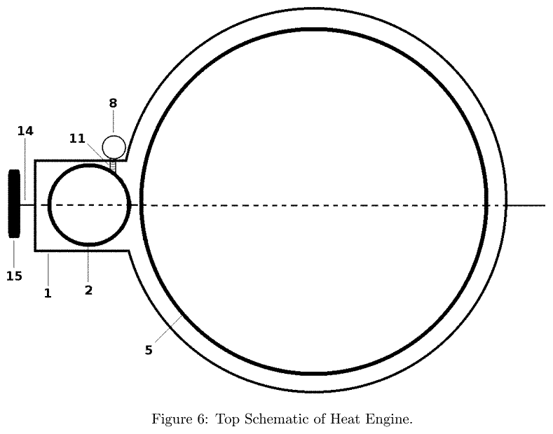

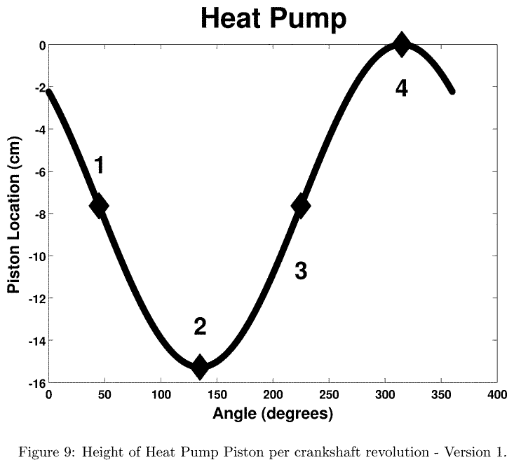

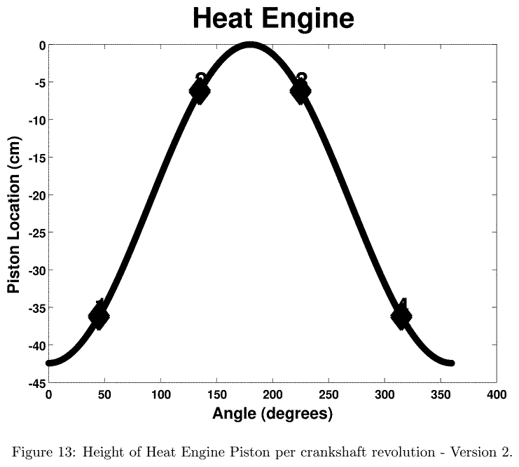

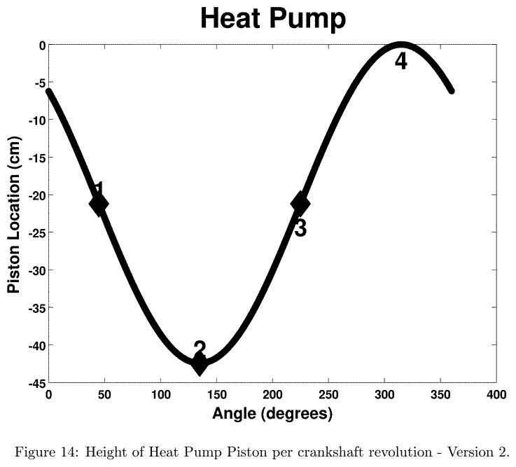

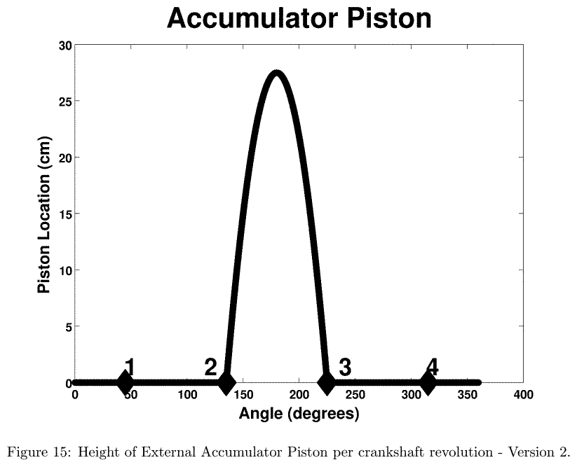

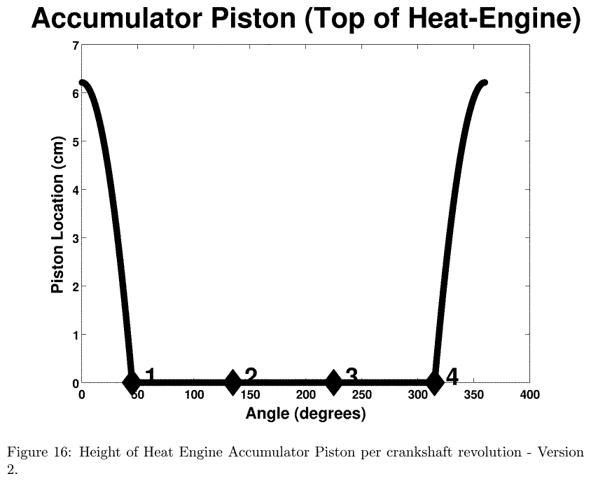

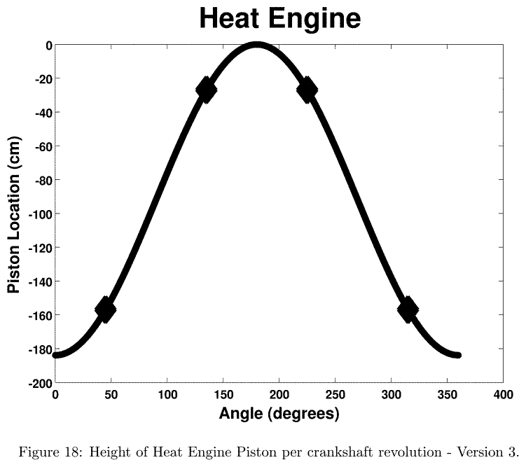

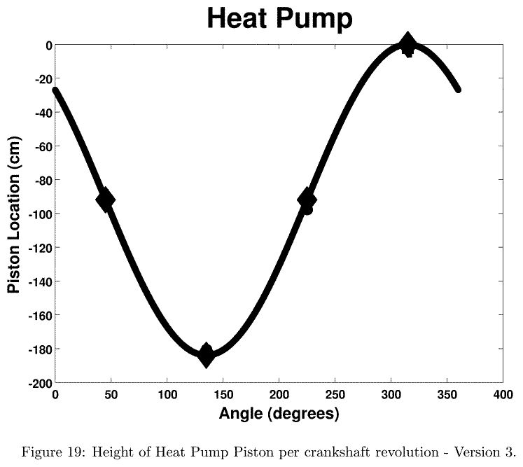

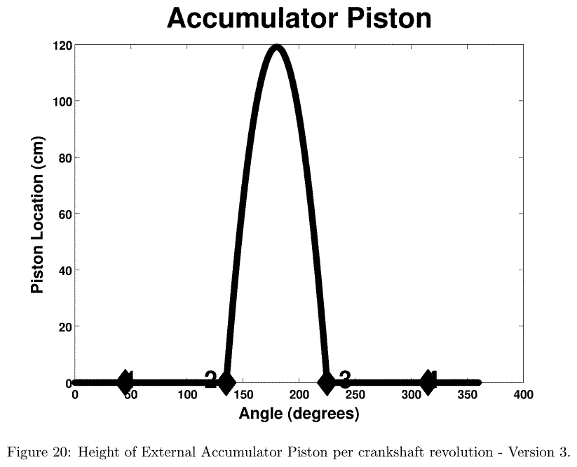

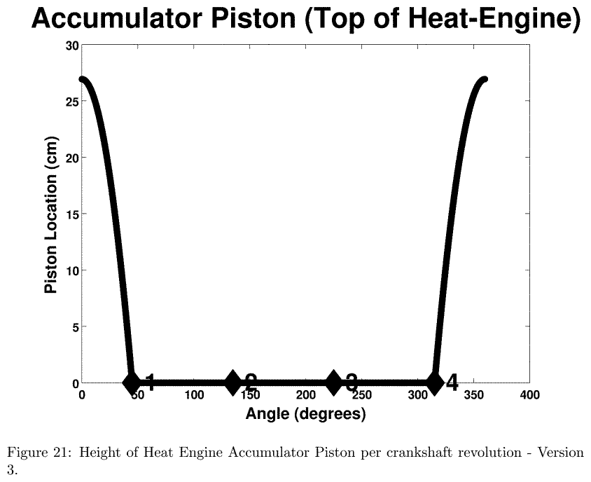

An example of this engine cycle being practically implemented is represented in FIG. 1-21. In this primary example, the engine is a sealed cylinder (Part 2), 105 mm bore and 152.7 mm in width and stroke. The inner wall of the heat engine cylinder (Part 2) has a tungsten disulfide (WS₂) dry lubrication, with a coefficient of kinetic friction of 0.03. This engine contains two pistons within the single cylinder: the actual engine piston (Part 3) attached to the crank-shaft (Part 14) by a connecting rod (Part 12) on the bottom, and the top accumulator piston (Part 18). The pistons (Part 3 and Part 18) shall be sealed with two 2 mm thick piston rings, of hard steel but also coated with tungsten disulfide (WS₂) dry lubrication, with a coefficient of kinetic friction of 0.03. The working fluid of the engine is 33.3545 grams of argon (Part 4), sealed between the two pistons. Below the engine piston (Part 3) is ambient air or a vacuum; above the top accumulator piston is 1.1676 grams of helium (Part 20). A physical obstruction (Part 19) will prevent the top accumulator piston from compressing the helium beyond a pressure of 2.1744 MPa at the high temperature of 25° C., allowing for a minimum cylinder length of 38.4286 mm, or 332.754 cm³ of minimum volume. The top accumulator piston is thermally sealed, and the sealed helium (Part 20) is thermally exposed to the 25° C. surrounding ambient fluid.

This engine cylinder (Part 2) is contained in a sealed pressure vessel (Part 1) filled with ideal gas helium (Part 7). The volume of this chamber is expanded and compressed by a proximate heat pump piston (Part 6) within a cylinder (Part 5) that is open to the pressure vessel's volume. This cylinder (Part 5) shall have a larger bore of 1.7564 meters and a length and stroke of 152.7 mm (same as the heat engine cylinder Part 2); the inner wall of the cylinder (Part 5) has a tungsten disulfide (WS₂) dry lubrication, with a coefficient of kinetic friction of 0.03. The piston (Part 6), which is connected to the crankshaft (Part 14) by a connecting rod (Part 13), shall be sealed with two 2 mm thick piston rings, of hard steel but also coated with tungsten disulfide (WS₂) dry lubrication, with a coefficient of kinetic friction of 0.03. The stroke of this piston shall be the full 152.7 mm length of the cylinder. The pressure vessel (Part 1) shall encompass a total volume of 0.1313 m³ if the heat pump piston (Part 6) is at Top Dead Center; the total volume of this helium (Part 7) shall expand to 0.5013 m³ when the heat pump piston (Part 6) is at Bottom Dead Center; the compression ratio is 3.8187. The mass of helium (Part 7) within the heat pump cylinder (Part 5) and pressure vessel (Part 1) is 0.5 kg. The pressure of this mass of helium when the heat pump piston is at Bottom Dead Center and the cycle is at the low temperature of −78° C. is 4 atmospheres (404.54 kPa); the pressure of this mass of helium when the heat pump piston is at Top Dead Center and the cycle is at the high temperature of 25° C. is 1.5448 MPa.

The purpose of the heat pump piston (Part 6) and cylinder (Part 5) compressing this 0.5 kg of helium (Part 7) is to allow the Stirling cycle heat engine to operate without regeneration. When the heat engine is undergoing isochoric cooling (Stage 4 to 1) from 25° C. to −78° C., and continuing during isothermal compression at −78° C. (Stage 1 to 2), the heat pump is expanding and absorbing the energy entirely. The heat pump piston (Part 6) is at Top Dead Center when the heat engine cycle is at Stage 4, and the heat pump piston (Part 6) is at Bottom Dead Center when the heat engine cycle is at Stage 2, as observed in Figure ??. The purpose of the heat pump is to provide both heating and cooling to the Stirling cycle heat engine. During the isochoric heating (Stage 2 to 3) from −78° C. to 25° C. and during the isothermal expansion (Stage 3 to 4), the heat pump piston (Part 6) is compressing back to Top Dead Center, providing heat to the argon working fluid (Part 4). As demonstrated in this thermodynamic cycle, the net heat input Q₂₃+Q₃₄ exceeds the net heat output Q₄₁+Q₁₂, and thus this heat pump does not provide the entirety of the heat input for the cycle.

The heat pump is (thermodynamically) a fully reversible cycle; the helium compresses to a hotter temperature of 25° C. and a pressure of 1.5448 MPa, and expands back to a temperature and pressure of −78° C. and 404.54 kPa. There is energy loss from friction: with a friction coefficient of 0.03 due to the tungsten disulfide dry lubricant coating, and a piston ring load to equal the maximum stress 1.5448 MPa of the helium to prevent leakage. The energy lost W_{f,hp} (J) from one revolution of the heat pump is

W_{f,hp}=Fₚᵣ·μ_{COF}·sₕₚ·2,

where μ_{COF} is the coefficient of friction (0.03), sₕₚ (m) is the heat pump stroke of 152.7 mm, and Fₚᵣ (N) is the force of the piston rings. The stroke is multiplied by a factor of two, as the distance is traveled in both compression and expansion. Assuming the two piston rings are 2 mm in length, surrounding the circumference of the piston (bore of 1.7564 m), and the applied stress is 1.5448 MPa to ensure a seal of the helium at the maximum pressure, the force from the piston ring Fₚᵣ is thus

$${F}_{p r} = {σ}_{p r} \cdot L \cdot \frac{π}{4} \cdot {d}_{h p}^{2} ,$$

where σₚᵣ (Pa) is the stress of the piston ring (1.5448 MPa), dₕₚ represents the bore of the heat pump (1.7564 m), and L (m) presents the combined length of the two 2-mm piston rings (L=4 mm). The total mechanical work lost from friction from a single cycle of the heat pump W_{f,hp} (J) is therefore

$$\begin{matrix}{W}_{f , hp} = {σ}_{p r} \cdot L \cdot \frac{π}{4} \cdot {d}_{hp}^{2} \cdot {μ}_{COF} \cdot {s}_{h p} \cdot 2 , \\ {W}_{f , hp} = 1 , 544 , 800 \cdot 0.004 \cdot \frac{π}{4} \cdot {1.7564}^{2} \cdot 0.03 \cdot 0.1527 \cdot 2 , \\ = 18.6795\end{matrix} \qquad ( 20 )$$

To achieve the thermodynamic efficiency that exceeds the Carnot efficiency, reversible isochoric heating and cooling is utilized. If the cycle were modified to be a Carnot cycle where the working fluid was heated and cooled by adiabatic compression and expansion, then the pressures would be either impractically high at Stage 3 or the intermolecular forces would be two weak during the isothermal compression (Stage 1 to 2), adding to the mechanical work input and reducing the thermodynamic efficiency.

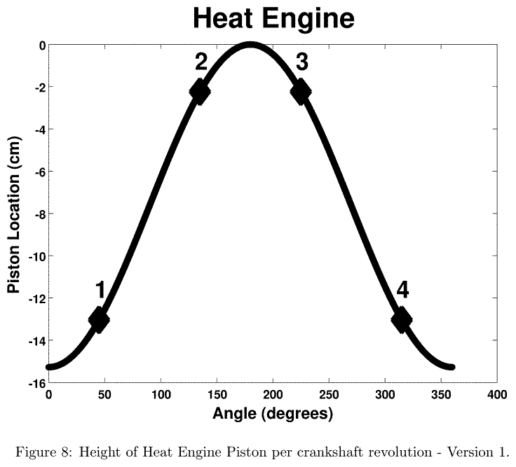

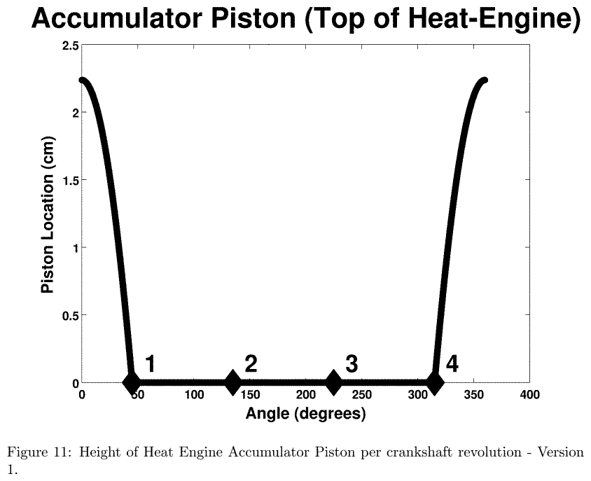

To achieve isochoric heating and cooling, two accumulator pistons and cylinders are utilized, so that the volume remains close to constant as the temperature of the argon and helium increases and decreases. The top accumulator piston (Part 18) is prevented by an obstruction (Part 19) from moving closer than 38.4286 mm to the top of the cylinder, resulting in a minimum volume of 332.7540 cm³; the 1.1676 grams of helium (Part 20) is at a pressure of 2.1744 MPa and a temperature of 25° C. when the accumulator piston is at the maximum height. During isochoric cooling (Stage 4 to 1), when the temperature of the argon decreases from 25° C. to −78° C., the pressure of the argon working fluid decreases from 2.1744 MPa to 1.3744 MPa. During this cooling, the heat engine piston (Part 3) will still be in motion, and as a result helium (Part 20) above the accumulator piston (Part 18) will expand, pushing the piston (Part 18) a distance of 22.368 mm down the heat engine cylinder (Part 2). The helium (Part 20) will remain at a temperature of 25° C., as the piston (Part 18) is a thermal insulator; the pressure of this helium will decrease from from 2.1744 MPa to 1.3744 MPa, in equilibrium with the argon working fluid (Part 4). The movement of the heat engine piston (Part 3) is tracked in FIG. 8, and the movement of the accumulator piston (Part 18) is tracked in FIG. 11.

The loss of friction per cycle W_{f,top-piston} (J) from the top accumulator piston (Part 18) traveling up and down 22.368 mm in the heat engine cylinder (Part 2) is calculated with equation 20

$$\begin{matrix}{W}_{f , top \text{-} piston} = {σ}_{p r} \cdot L \cdot \frac{π}{4} \cdot {d}_{he}^{2} \cdot {μ}_{COF} \cdot {s}_{tp} \cdot 2 , \\ {W}_{f , hp} = 20 , 605 , 800 \cdot 0.004 \cdot \frac{π}{4} \cdot {0.105}^{2} \cdot 0.03 \cdot 0.022368 \cdot 2 , \\ = 36.4887 ,\end{matrix} \qquad ( 21 )$$

where dₕₑ (m) is the heat engine cylinder (Part 2) bore of 105 mm, and sₜₚ (m) is the 22.368 mm distance the top accumulator piston (Part 18) travels per cycle. The friction loss for this accumulator piston is clearly greater than the loss for the heat pump piston, as the piston rings are a tighter fit to accommodate the higher maximum pressure of 20.6058 MPa rather than 1.5448 MPa.

To achieve isochoric heating, a second accumulator cylinder (Part 8) and accumulator piston (Part 9) is external to the pressure vessel (Part 1). This accumulator cylinder (Part 8) is thermally conductive with the 25° C. surrounding ambient fluid. Identical to the heat engine cylinder (Part 2) and heat pump cylinder (Part 5), this accumulator cylinder (Part 8) also has a stroke and length of 152.7 mm. The accumulator cylinder (Part 8) has a bore of 38.3332 mm, and contains 2.7516 grams of helium (Part 10). When the accumulator is at Bottom Dead Center, the helium gas (Part 10) has a volume of 176.2703 cm³, a temperature of 25° C., and a pressure of 9.6737 MPa, the same pressure as the argon working fluid (Part 4) at Stage 2. When the argon working fluid (Part 4) starts to heat up from −78° C. to 25° C., the accumulator piston (Part 9) compresses the helium (Part 10) and allowing the argon working fluid (Part 4) to flow into the accumulator cylinder (Part 8), resulting in the volume of the argon working fluid (Part 4) remaining constant during the isochoric heating. When the heat engine reaches Stage 3, the heat engine piston (Part 3) is at Top Dead Center, all of the argon working fluid (Part 4) is contained in the accumulator cylinder (Part 8) at a temperature of 25° C. and pressure of 20.6058 MPa; the accumulator helium (Part 10) is also at a temperature of 25° C. and pressure of 20.6058 MPa, compressed by a factor of 2.1301 as the volume of the accumulator helium (Part 10) decreases from 176.2703 cm³ to 82.7529 cm³.

All of these four sealed regions can be filled with their respective fluids, three with Helium and one with Argon, via a ball valve and a gas connector. These four regions shall be filled both at the initial construction of the engine, and to mitigate against gas leakage.

Since the accumulator helium (Part 10) is an ideal gas (equation 15) at a constant temperature of 25° C., the volume decrease is proportional to the pressure increase, and thus the distance traveled δs_{accum} (m) by the accumulator piston (Part 9) is proportional to both the accumulator cylinder (Part 8) stroke of 152.7 mm and the accumulator helium (Part 10) compression ratio ϕₐ of 2.1301

$$δ {s}_{accum} = {s}_{accum} \cdot \frac{{φ}_{a}}{{φ}_{a} + 1} = 152.7 \cdot \frac{2.1301}{2.1301 + 1} = 0.1 \; 039 , \qquad ( 22 )$$

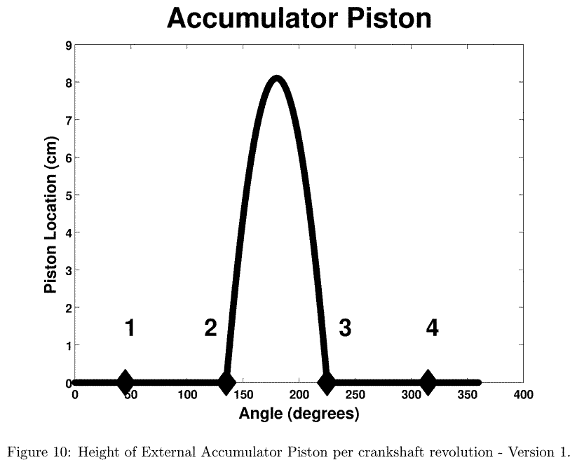

and the loss of friction per cycle W_{f,accum} (J) is calculated with equation 20

$$\begin{matrix}{W}_{f , accum} = {σ}_{p r} \cdot L \cdot \frac{π}{4} \cdot {d}_{accum}^{2} \cdot {μ}_{COF} \cdot {s}_{accum} \cdot \frac{{φ}_{a}}{{φ}_{a} + 1} \cdot 2 , \\ {W}_{f , hp} = 20 , 605 , 800 \cdot 0.004 \cdot \frac{π}{4} \cdot {0.0383332}^{2} \cdot 0.03 \cdot 0.1527 \cdot \\ \frac{2.1301}{2.1301 + 1} \cdot 2 , \\ = 61.9022 ,\end{matrix} \qquad ( 23 )$$

where ϕₐ is the accumulator compression ration of 2.1301, s_{accum} (m) is the accumulator length of 152.7 mm, and d_{accum} (m) is the accumulator diameter of 38.3332 mm. The distance traveled of this accumulator piston is tracked in FIG. 10. The friction loss for this accumulator piston is clearly greater than the loss for the heat pump piston, as the piston rings are a tighter fit to accommodate the higher maximum pressure of 20.6058 MPa rather than 1.5448 MPa. This accumulator cylinder (Part 8) is thermally conductive to the 25° C. surrounding ambient fluid, and all of the heat input to the argon working fluid (Part 4) during Stage 2 to 4 that was not obtained from the heat pump piston (Part 6) is obtained within this accumulator.

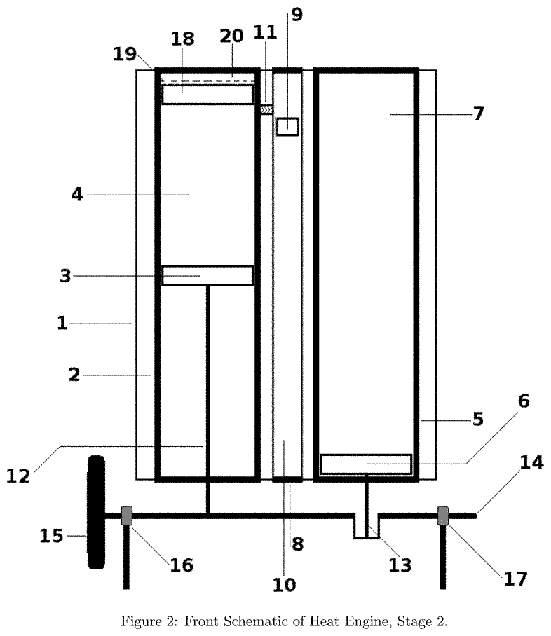

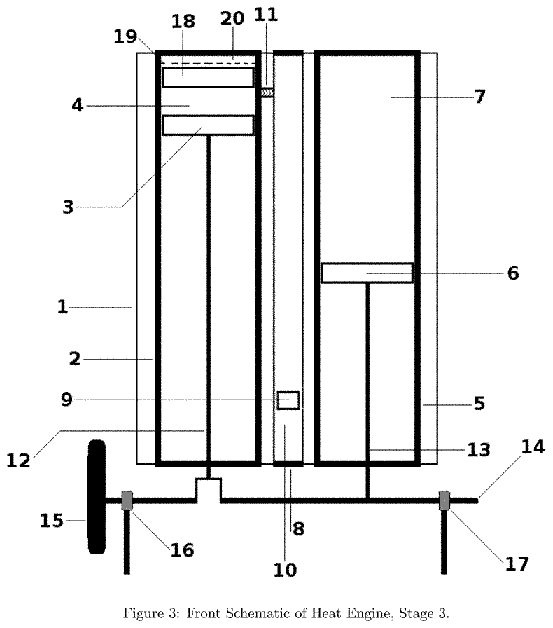

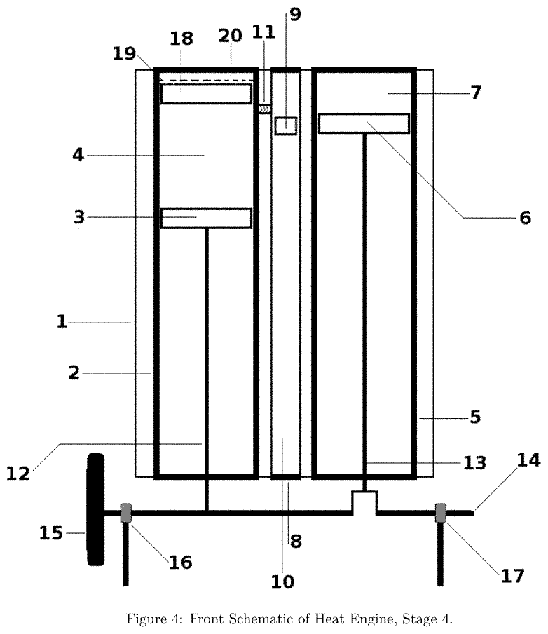

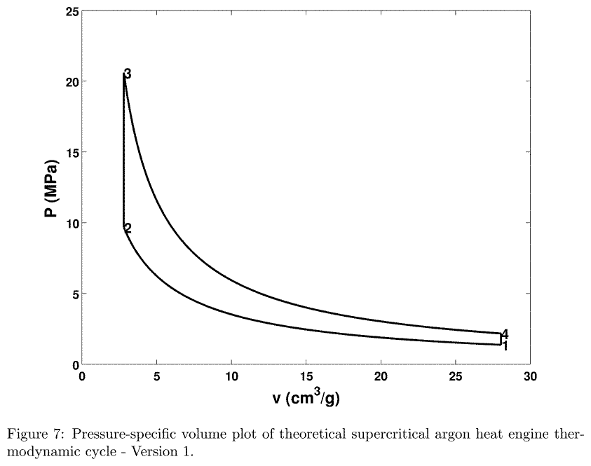

The heat engine operates under the thermodynamic cycle described in Table 2 and in FIG. 7. At Stage 1 (FIG. 1), the heat engine piston (Part 3) is at the Bottom Dead Center position of the heat engine cylinder (Part 2), the top accumulator piston (Part 18) is at its low position, the heat pump piston (Part 6) is in the center of the cylinder (Part 5), and the accumulator piston (Part 9) is at Bottom Dead Center. At Stage 2 (FIG. 2), the heat engine piston (Part 3) is at the center of the heat engine cylinder (Part 2), the top accumulator piston (Part 18) is at its high position stopped by the obstruction (Part 19), the heat pump piston (Part 6) is in the Bottom Dead Center position of the cylinder (Part 5), and the accumulator piston (Part 9) is at Bottom Dead Center. At Stage 3 (FIG. 3), the heat engine piston (Part 3) is at the Top Dead Center position of the heat engine cylinder (Part 2), the top accumulator piston (Part 18) is at its high position stopped by the obstruction (Part 19), the heat pump piston (Part 6) is in the center position of the cylinder (Part 5), and the accumulator piston (Part 9) has compressed the helium (Part 10). Finally, at Stage 4 (FIG. 4), the heat engine piston (Part 3) is at the center of the heat engine cylinder (Part 2), the top accumulator piston (Part 18) is at its high position stopped by the obstruction (Part 19), the heat pump piston (Part 6) is in the Top Dead Center position of the cylinder (Part 5), and the accumulator piston (Part 9) is at Bottom Dead Center.

The loss of friction per cycle W_{f,he} (J) from the heat engine piston (Part 3) traveling up and down 152.7 mm in the heat engine cylinder (Part 2) is calculated with equation 20

$$\begin{matrix}{W}_{f , he} = {σ}_{p r} \cdot L \cdot \frac{π}{4} \cdot {d}_{he}^{2} \cdot {μ}_{COF} \cdot {s}_{he} \cdot 2 , \\ {W}_{f , hp} = 20 , 605 , 800 \cdot 0.004 \cdot \frac{π}{4} \cdot {0.105}^{2} \cdot 0.03 \cdot 0.1527 \cdot 2 , \\ = 352.3664 ,\end{matrix} \qquad ( 24 )$$

where dₕₑ (m) is the heat engine cylinder (Part 2) bore of 105 mm, and sₕₑ (m) is the 152.7 mm distance the heat engine piston (Part 3) travels per cycle. The friction loss for this accumulator piston is clearly greater than the loss for the heat pump piston, as the piston rings are a tighter fit to accommodate the higher maximum pressure of 20.6058 MPa rather than 1.5448 MPa.

The thermodynamic calculations determined that net total energy out per kg of argon working fluid is

Wₙₑₜ=Wₒᵤₜ−Wᵢₙ=136, 064−78, 237=57, 827.

This heat engine was designed with an equivalent length of 108 mm for the 105 mm heat engine cylinder during the expanded Stage 4 and Stage 1, when the specific volume (Table 2) is 2.80374 cm³/g; hence the mass of the argon working fluid (part 4) is 33.3545 grams. The net mechanical energy output per revolution of this engine W_{net,he} (J), deducting for friction, is

$$\begin{matrix}{W}_{n e t , h e} = ( 0.0333545 \cdot 57 , 827 ) - \\ ( {W}_{f , h e} - {W}_{f , a c c u m} - {W}_{f , top \text{-} p ι s t o n} - {W}_{f , h p} ) \\ = ( 0.0333545 \cdot 57 , 827 ) - \\ ( 352.3664 - 61.902 \; 2 - 36.4887 - 18.67 \; 95 ) , \\ = 1 , 92 \; 8.7890 - 469.4368 , \\ = 1 , 45 \; 9.35 \; 22.\end{matrix} \qquad ( 25 )$$

If the cycle operates at a speed of 600 RPM, the net energy output of the engine is 14.593522 kW, or 19.5702 horsepower. This engine demonstrates a practical example of using the temperature dependent intermolecular dispersion forces, defined in equation 14 and which the experimental evidence demonstrates decreases with temperature, to reduce the net entropy in the universe and obtain useful mechanical energy from the small temperature differentials with the ambient fluid.

This design is not the exclusive design of this engine; there are countless sizes it can be scaled up or down depending on the need or applications. While in theory, any size engine can be designed, because of the limit of friction, a computer simulation was needed to determine what a reasonable friction assumption is (for the WS₂ coating and the 2 mm thin piston ring seals.

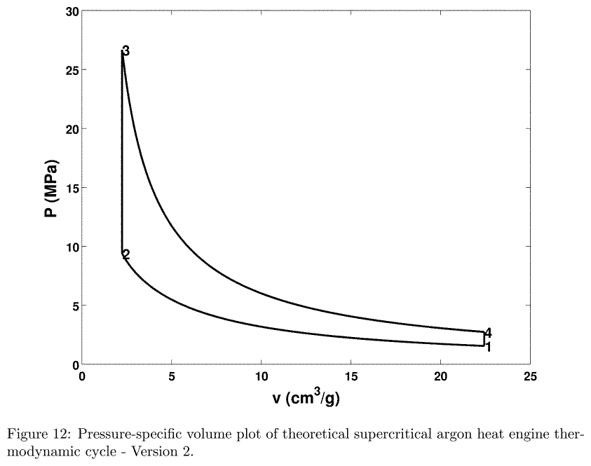

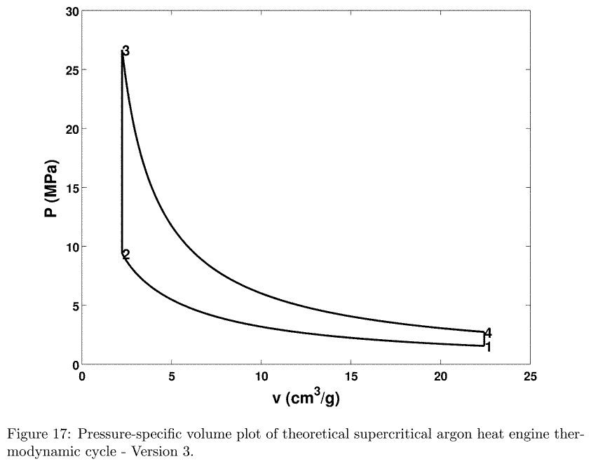

The larger the power output of the engine, the greater the size; this limitation must be realized in the design of one of these engines. The 19 HP example (FIGS. 7-11) described in detail has 373 liters of displacement (0.043 hp/liter) is just one example; such an engine can be used to supplement a single family residence, supplying about 100 amps at 120 Volts. Another example at 884 liters to produce 264 horsepower (0.2986 hp/liter), with applications such as in a factory or industrial environment (FIGS. 12-16). A third example (FIGS. 17-21) supplies 70,482 horsepower with a displacement of 284 m³ (0.248 hp/liter), and is idea as a supplemental supply for a power station, and can possibly be used on a large mobile station such as a locomotive or a ship. All of the design specifications for this three arbitrary examples are listed in Table 3.

TABLE 3

| | Study 1 | | Study 2 | | Study 3 | |
|---|---|---|---|---|---|---|
| W in (J/kg) | 78,236.8414 | | 67,094.2521 | | 67,094.2521 | |
| W out (J/kg) | −136,063.743 | | −137,325.6308 | | −137,325.6308 | |
| dU L (J/kg) | −52,435.4134 | | −78,130.4136 | | −78,130.4136 | |
| dU H (J/kg) | 17,697.1776 | | 15,195.6424 | | 15,195.6424 | |
| Q12 (J/kg) | −130,672.2548 | | −145,224.6657 | | −145,224.6657 | |
| Q23 (J/kg) | 68,097.293 | | 102,419.7107 | | 102,419.7107 | |
| Q34 (J/kg) | 153,760.9206 | | 152,521.2732 | | 152,521.2732 | |
| Q41 (J/kg) | −33,359.0572 | | −39,484.9396 | | −39,484.9396 | |
| Efficiency Carnot | 0.34545 | | 0.4 | | 0.4 | |
| Bore HE | 0.105 | m | 0.3 | m | 1.3 | m |
| Stroke HE | 0.108 | m | 0.3 | m | 1.3 | m |
| Compression Ratio HE | 10 | | 10 | | 10 | |
| Mass Argon | 33.3545 | g | 945.423 | g | 76.93 | kg |
| Vol. of HE (BDC) | 935.1736 | cm³ | 21205.7504 | cm³ | 1.725519.765 | m³ |
| Vol. of HE (TDC) | 93.5174 | cm³ | 2120.575 | cm³ | 0.172551.9765 | m³ |
| Heat in and out of HP | −5,471.1865 | J | −174,628.7164 | J | −14209603.3315 | J |
| Mass Helium in HP | 500 | g | 2.5 | kg | 1,000 | kg |
| Stroke HP | 152.7351 | mm | 424.2641 | mm | 1.8384776 | m |
| Bore HP | 1.758 | m | 1.59789 | m | 13.9591746 | m |
| Pressure HP (BDC) | 0.40454 | MPa | 1.1 | MPa | 1.1 | MPa |
| Pressure HP (TDC) | 1.5528 | MPa | 276.0148 | MPa | 6.2316 | MPa |
| Compression Ratio HP | 3.8384 | | 250.9225 | | 5.6651 | |
| Accum. Vol. (BDC) | 176.2703 | cm³ | 3,272.9931 | cm³ | 266,324.6587 | cm³ |
| Accum. Vol. (TDC) | 82.7529 | cm³ | 1,152.418 | cm³ | 93,772.6822 | cm³ |
| Accum. Pressure Ratio | 2.1301 | | 2.8401 | | 2.8401 | |
| Accum. Bore | 38.3332 | mm | 99.1082 | mm | 429.4688 | mm |
| Accum. Stroke | 152.7351 | mm | 424.2641 | mm | 1,838.4776 | mm |
| Mass Helium Accum. | 2.7516 | g | 49.0631 | g | 3.9923 | kg |
| Lx1 | 22.3675 | mm | 62.132 | mm | 269.2388 | mm |
| Lx2 | 38.4286 | mm | 81.5858 | mm | 353.5385 | mm |
| Mx | 1.1676 | g | 25.2066 | g | 2.051 | kg |
| W_{friction} (per cycle): | 469.4368 | J | 46,661.408 | J | 146,960.1156 | J |
| Net Work Out (per cycle): | 1,459.3522 | J | 19,736.9555 | J | 5,255,899.3107 | J |
| Power Out (600 RPM): | 19.5702 | hp | 264.6769 | hp | 70,482.7586 | hp |
| Total Displacement: | 0.37223 | m³ | 0.88405 | m³ | 284.07 | m³ |

Lx1 = Length of Top Piston in Heat Engine Stroke.
Lx2 = Length of Top Piston obstruction in Heat Engine.
Mx = Mass of Helium in Top Piston obstruction in Heat Engine.
HE = Heat Engine.

What I claim is:

1. A method of operating a mechanical heat engine according to an internally reversible, thermodynamic cycle, comprising:
providing a gas in a piston-cylinder system at bottom dead center, at a temperature exceeding the critical temperature and a density less than but within an order of magnitude of the critical density;
isothermally compressing the gas in the piston-cylinder system to a near supercritical density at top dead center;
isochorically heating the fluid in the piston-cylinder system to a hotter temperature at top dead center;
isothermally expanding the high-pressure super-critical gas to bottom dead center; and
isochorically cooling the gas in the piston-cylinder system back to the initial cooler temperature of the gas, maintaining the piston at bottom dead center.

2. A method of operating a mechanical heat engine according to an internally reversible, thermodynamic cycle, comprising a proximate heat pump that utilizes small temperature differentials in the surrounding ambient fluids to provide a cold temperature sink.

3. The method of claim 1, wherein thermodynamic efficiency of the heat engine is increased by utilizing the intermolecular attractive Van der Waal forces present in fluids approximate to supercritical density.

4. The method of claim 1, further comprising a piston accumulator designed to keep the working fluid at a constant volume during isochoric heating and cooling, while allowing for continuous motion of the heat engine piston.

5. The method of claim 2, wherein the heat engine is heated by small temperature differentials in ambient surrounding fluids.

6. The method of claim 2, wherein isochoric heating and cooling of the heat engine results from reversible compression and expansion of a piston filled with an ideal-gas working fluid to minimizes the temperature difference between heat transfer and maximize the efficiency of the cycle.

7. The method of claim 2, wherein the heat pump utilizes a mechanical energy input from a crank shaft that is also connected to the supercritical Stirling cycle heat engine; and:
the crankshaft is connected to the heat engine and heat pump piston via a connecting rod.

8. The method of claim 7, wherein the crankshaft maintains angular momentum via an attached flywheel, and recovers the mechanical rotational energy consumed by the heat pump.

9. The method of claim 3, wherein enhanced thermodynamic efficiency causes a net positive mechanical work generated to the crankshaft and flywheel.

10. The method of claim 9, wherein the net output allows for the entire machine to function as a mechanical energy generator, utilizing small temperature differences from the surrounding ambient fluids as an input, to generate useful rotating mechanical energy as an output.

11. The method of claim 1 wherein both the heat engine and heat pump are contained in a sealed chamber that allows the working fluid of the heat pump to surround and provide heating and cooling to the cylinder.

12. The method of claim 11, wherein the working fluid of the heat pump that surrounds the heat engine shall contain Helium.

13. The method of claim 4, wherein a secondary piston is installed in the heat engine cylinder, above the primary heat engine piston, where:
an ideal gas working fluid is physically and thermally sealed from the supercritical working fluid of the heat engine;
the ideal gas working fluid is thermally connected to the ambient surrounding fluid at a constant temperature;
an obstruction remains, preventing the upper piston from compressing the ideal gas working fluid to a pressure greater than the design pressure of the supercritical working fluid, when the lower heat engine piston is at Bottom Dead Center, and the supercritical working fluid is at the hottest design temperature; and
the accumulator is assembled in such a manner as to allow isochoric cooling of the supercritical working fluid, by the ideal gas working fluid expanding the upper piston in synchronization with the heat engine piston expanding the supercritical working fluid.

14. The method of claim 4, further comprising utilizing a piston accumulator assembled outside a sealed chamber, where:
the accumulator is filled with an ideal gas working fluid;
the accumulator is thermally connected to the surrounding ambient environment;
the accumulator is connected by a manifold to the supercritical working fluid of the heat engine;
the accumulator working fluid pressure at top dead center is equal to the supercritical heat engine fluid pressure when the supercritical Stirling cycle heat engine piston is at Top Dead Center and the temperature of the supercritical and working fluid is the same temperature as the cold sink;
the accumulator working fluid pressure at bottom dead center is equal to the supercritical heat engine fluid pressure when the supercritical Stirling cycle heat engine piston is at Bottom Dead Center Dead Center and the temperature of the supercritical and working fluid is the same temperature as the surrounding ambient temperature;
the accumulator allows for heating of the supercritical working fluid from the surrounding ambient fluid when the supercritical fluid is within the accumulator cylinder; and
the accumulator is assembled in such a manner as to allow isochoric heating of the supercritical working fluid, by the accumulator working fluid compressing in synchronization with the heat engine piston compressing the supercritical working fluid.

15. The method of claim 14, whereby the pistons for the heat engine, the heat pump, and the accumulator are sealed with two piston rings, each ring 2 mm thick, and both the piston rings and the cylinder walls lubricate with a tungsten disulfide (WS2) dry lubricant coating.

16. The method of claim 1, further comprising the step of utilizing the monatomic fluid argon as the supercritical working fluid for the supercritical Stirling cycle heat engine.

17. The method of claim 2, further comprising the step of utilizing the monatomic fluid Helium as the ideal gas working fluid of the heat pump.

18. The method of claim 13, further comprising the step of utilizing the monatomic fluid Helium as the ideal gas working fluid of the upper piston with the heat engine cylinder.

19. The method of claim 14, further comprising the step of utilizing the monatomic fluid Helium as the ideal gas working fluid of the piston accumulator.
